(19) United States
(12) Patent Application Publication
(10) Pub. No.: US 2025/0159064 A1
(43) Pub. Date: May 15, 2025

(54) DATA TRANSMISSION METHOD AND SYSTEM FOR INTERNET OF THINGS DEVICES

(71) Applicant: BEIJING UNIVERSITY OF POSTS AND TELECOMMUNICATIONS, Beijing (CN)

(72) Inventors: Bo He, Beijing (CN); Haoran Zhao, Beijing (CN); Qi Qi, Beijing (CN); Yuhan Jing, Beijing (CN); Jingyu Wang, Beijing (CN); Jing Wang, Beijing (CN)

(21) Appl. No.: 18/541,472

(22) Filed: Dec. 15, 2023

(30) Foreign Application Priority Data
Nov. 14, 2023 (CN) 202311511255.X

(51) Int. Cl. H04L 69/324; H04L 69/164

(52) U.S. Cl. CPC H04L 69/324; H04L 69/164

(57) ABSTRACT

A data transmission method and system for Internet of Things devices, includes: by a machine type communication gateway, reading, short data packets sent by all of the Internet of Things devices, acquiring QUIC data streams corresponding to the Internet of Things devices sending the short data packets, and placing data in the short data packets into to-be-sent queues for the acquired QUIC data streams; by the machine type communication gateway, newly creating an empty data packet; popping up, in chronological order in which to-be-sent data is placed into the to-be-sent queues for the QUIC data streams, the to-be-sent data one by one from a to-be-sent queue for each of QUIC data streams that contains the to-be-sent data; encapsulating the popped-up to-be-sent data into a streamframe and then loading the streamframe into the newly created data packet; and finally sending the data packet loaded with multiple streamframes to a central base station. The present disclosure relates to the field of information communication networks, which can guarantee an integrity of the original data of a short data packet based on a scenario with massive Internet of Things, and can effectively reduce the number of data packets and the total amount of data forwarded from the machine type communication gateway to a central base station.

### TECHNICAL FIELD

The disclosure relates to a data transmission method and system for Internet of Things devices, which belong to the field of information communication networks.

### BACKGROUND

Massive Internet of Things is one of emerging network scenarios in the 5G/6G era. In a scenario in which massive Internet of Things are typically cluster-deployed, massive Internet of Things devices need to connect to multiple Machine Type Communication Gateways (MTCG) for data packet transmission. The cluster-based network adopts a two-hop transmission architecture, which divides the data transmission for Internet of Things devices into an intra-cluster transmission phase and a machine type communication gateway forwarding phase. During the intra-cluster transmission phase, the Internet of Things devices use lower power to send data packets containing status update information to their associated machine type communication gateways, rather than to a central base station. During the machine type communication gateway forwarding phase, the machine type communication gateways disassemble the received data packets, assemble new data packets, and sends these new packets to the base station.

Although the Internet of Things devices send a large number of data packets, the data packets contain less valid content and a size of the data packets is smaller. Therefore, aggregating the received short data packets at the machine type communication gateways is a common solution to reduce the pressure on the central base station. The main solutions for aggregating short data packets are divided into two categories: a lossy aggregation and a lossless aggregation. The lossy aggregation solution refers to that the machine type communication gateways disassemble the short data packets from the massive Internet of Things devices, extract valid data (such as temperature values, humidity values, etc.), and calculate a summary value for valid data of the same type (such as calculate the maximum/minimum/average/variance, etc.) and forward the calculated value to the central base station, thereby reducing the number of data packets received by the central base station. The lossless aggregation solution refers to that the machine type communication gateways concatenate multiple short data packets from the massive Internet of Things devices into a larger data packet for forwarding, in order to reduce the number of data packets received by the central base station.

Both of the above main short data packet aggregation technologies running on machine type communication gateways have defects. The lossy aggregation solution can only calculate a summary value for short data packets that carry the valid data of the same type, for example, for short data packets that all carry temperature data, and the central base station can only receive summary data, therefore, all original data from massive Internet of Things devices is discarded and the data integrity is loss. The lossless aggregation solution guarantees the integrity of the original data sent by the Internet of Things devices, but the total amount of data (including the valid data of the original short data packet and the number of header bytes) received by the central base station has not reduced, and only the number of data packets received by the central base station is reduced.

Therefore, how to guarantee the integrity of the original data of short data packets based on the scenario with massive Internet of Things while effectively reducing the number of and total amount of data packets forwarded by the machine type communication gateways to the central base station, has become a key technical issue that the skills focus on.

### SUMMARY

In view of this, the object of the present disclosure is to provide a data transmission method and system for Internet of Things devices, which can guarantee an integrity of original data of short data packets based on a scenario with massive Internet of Things, and can effectively reduce the number of data packets and the total amount of data forwarded from a machine type communication gateway to a central base station.

In order to achieve the above object, the present disclosure provides a data transmission method for Internet of Things devices, wherein a machine type communication gateway collects information of all of Internet of Things devices connected to the machine type communication gateway, allocates one QUIC (Quick UDP Internet Connection) data stream to each of the Internet of Things devices connected to the machine type communication gateway, and constructs one to-be-sent queue for each QUIC data stream; when the machine type communication gateway receives short data packets sent by the Internet of Things devices, the method includes:
Step 1. by the machine type communication gateway, reading the short data packets sent by all of the Internet of Things devices, acquiring QUIC data streams corresponding to the Internet of Things devices sending the short data packets, and placing data in the short data packets into to-be-sent queues for the acquired QUIC data streams;
Step 2. by the machine type communication gateway, newly creating an empty data packet; popping up, in chronological order in which to-be-sent data is placed into the to-be-sent queues for the QUIC data streams, the to-be-sent data one by one from a to-be-sent queue for each of QUIC data streams that contains the to-be-sent data; encapsulating the popped-up to-be-sent data into one streamframe and then loading the streamframe into the newly created data packet; and finally sending the data packet loaded with multiple streamframes to a central base station.

In order to achieve the above object, the present disclosure further provides a data transmission system for Internet of Things devices, including a central base station, a machine type communication gateway and multiple Internet of Things devices, wherein the machine type communication gateway includes:
a device-data stream construction apparatus, configured to collect information of all of Internet of Things devices connected to the machine type communication gateway, allocate one QUIC data stream to each of the Internet of Things devices connected to the machine type communication gateway, and construct one to-be-sent queue for each QUIC data stream;
a data packet reading apparatus, configured to read short data packets sent by all of the Internet of Things devices, acquire QUIC data streams corresponding to the Internet of Things devices sending the short data packets, and place data in the short data packets into to-be-sent queues of the acquired QUIC data streams;
a data packet aggregation apparatus, configured to newly create an empty data packet; pop up, in chronological order in which to-be-sent data is placed into the to-be-sent queues of the QUIC data streams, the to-be-sent data one by one from a to-be-sent queue for each of QUIC data streams that contains the to-be-sent data; encapsulate the popped-up to-be-sent data into one streamframe and then load the streamframe into the newly created data packet; and finally send the data packet loaded with multiple streamframes to the central base station.

Compared with the prior art, the present disclosure has following beneficial effects: the present disclosure adopts the QUIC (Quick UDP Internet Connection) protocol, and provides, based on the support for a multi-stream multiplexing function by the QUIC protocol, a lossless aggregation technology that can be applied to uplink short packet communication for massive Internet of Things devices. The machine type communication gateway constructs an independent QUIC data stream for each Internet of Things device connected to the machine type communication gateway, aggregates valid data in the original short packets from different data streams, and forwards the aggregated data packet to the central base station. On the one hand, the integrity of valid data from uplink short data packets sent by the massive Internet of Things devices can be guaranteed, and after receiving the aggregated data packet forwarded by the machine type communication gateway, the central base station can restore the original valid data from each of the Internet of Things devices without loss. On the other hand, it not only effectively reduces the total number of data packets transmitted during the machine type communication gateway forwarding phase by aggregating the short data packets, but also effectively reduces the total amount of data transmitted during the machine type communication gateway forwarding phase by combining repeated low-level header bytes of respective original short packets during the aggregation process. Currently, network functions of most Internet of Things devices are based on a TCP protocol stack which is embedded in the kernels of the Internet of Things devices, and all development and updates of protocol stack function require modification and compilation of all device kernels, which is extremely difficult to implement. In view of the complexity and diversity of the Internet of Things devices in the real scenario with massive Internet of Things, the present disclosure uses the QUIC protocol to replace the common TCP protocol stack for the development of network functions for massive devices, which can get rid of the dependence of the TCP protocol stack on the kernel and run on all Internet of Things devices in the form of a software application, be decoupled from hardware devices, and have convenient deployability. The present disclosure runs multiple parallel QUIC data streams on the only one end-to-end connection between the machine type communication gateway and the central base station, which can isolate the transmission of multiple independent data streams, and can guarantee the integrity of valid data in the short data packets, which are sent by each Internet of Things device to the machine type communication gateway, during the forwarding process by constructing a one-to-one mapping relationship between the massive Internet of Things devices and the QUIC parallel data streams, thus the original valid data sent by the Internet of Things devices is completely saved as user data for the streamframe of each data stream, therefore, which thus can be read losslessly by the central base station and applications. The valid data contained in the uplink short data packets sent by the massive Internet of Things devices often has a length of only tens of bytes. Compared with the lengthy low-level data packet headers, a large amount of length in the short data packet is occupied by the data packet header that cannot be sensed by the application, resulting in a waste of resources. The final destination nodes of the uplink short data packets sent by the massive Internet of Things devices are all the central base station in the region, and these massive short data packets pass through the same path after passing through the machine type communication gateway. The present disclosure can significantly reduce the total amount of data sent in the network by combining low-level repeated headers, and encapsulate the valid data in the short data packets of the Internet of Things devices received by the machine type communication gateway as the streamframes of the QUIC data streams and load the streamframes into the data packet, thereby effectively reducing the number of the data packets and the total amount of data in the network while achieving short data packet aggregation.

### BRIEF DESCRIPTION OF THE DRAWINGS

FIG. 1 is a flow chart of a data transmission method for Internet of Things devices provided by a first embodiment of the present disclosure.

FIG. 2 is a schematic structure diagram of a QUIC data packet.

FIG. 3 is a flow chart of specific steps of Step 2 in FIG. 1.

FIG. 4 is a schematic structure diagram of a data transmission system for Internet of Things devices provided by a second embodiment of the present disclosure.

### DETAILED DESCRIPTION

In order to make the objective, technical solutions and advantages of the disclosure clearer, the disclosure will be described in detail below in combination with the accompanying drawings.

The present disclosure constructs, on a machine type communication gateway, an independent data stream for each Internet of Things device connected to the machine type communication gateway by using a multi-stream multiplexing function supported by the QUIC protocol. The machine type communication gateway aggregates valid data in original short data packets from different Internet of Things devices, and forwards the aggregated data packets to a central base station.

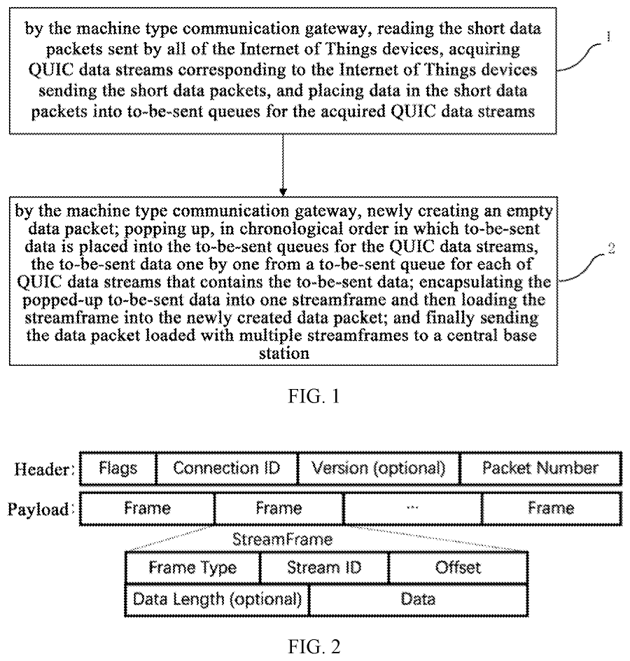

Referring to FIG. 1, FIG. 1 shows a data transmission method for Internet of Things devices provided by a first embodiment of the present disclosure, wherein a machine type communication gateway collects information of all of Internet of Things devices connected to the machine type communication gateway, allocates one independent QUIC data stream to each of the Internet of Things devices connected to the machine type communication gateway, and constructs one to-be-sent queue for each QUIC data stream; when the machine type communication gateway receives short data packets sent by the Internet of Things devices, the method includes:
Step 1. by the machine type communication gateway, reading the short data packets sent by all of the Internet of Things devices, acquiring QUIC data streams corresponding to the Internet of Things devices sending the short data packets, and placing data in the short data packets into to-be-sent queues for the acquired QUIC data streams;
Step 2. by the machine type communication gateway, newly creating an empty data packet; popping up, in chronological order in which to-be-sent data is placed into the to-be-sent queues for the QUIC data streams, the to-be-sent data one by one from a to-be-sent queue for each of QUIC data streams that contains the to-be-sent data; encapsulating the popped-up to-be-sent data into one streamframe and then loading the streamframe into the newly created data packet; and finally sending the data packet loaded with multiple streamframes to a central base station.

QUIC is a protocol that works over UDP and supports the multi-stream multiplexing function. As shown in FIG. 2, a QUIC packet structure includes a common header and a payload, and the payload consists of different numbers of frames. Each frame is an independent entry, carrying user data or a control signal. A type of frame that carries user data is referred to as a streamframe, and its Stream ID field indicates which stream it belongs to, thus a QUIC packet can load multiple streamframes without conflict. When the central base station receives a data packet containing multiple streamframes, it can disassemble the data packet and restore the entire payload into multiple independent streamframes, thus ensuring the data integrity of each stream during an end-to-end transmission. In this way, when the central base station receives the data packet sent from the machine type communication gateway, the method further includes:
by the central base station, disassembling the data packet sent by the machine type communication gateway into multiple streamframes, and reading a Stream ID in header information of each of the streamframes to acquire a corresponding QUIC data stream, then placing valid data read from the streamframe into a buffer area of an Internet of Things device corresponding to the QUIC data stream according to a corresponding relationship between the internet of Things devices and the QUIC data streams, to wait for being read by an application program, wherein the valid data is referred to data that does not contain the header information in the streamframe of the data packet.

The machine type communication gateway uses a network status sensing module to sense a connection relationship in a scenario with cluster-based massive Internet of Things, which includes a two-hop connection topology among massive Internet of Things devices—a machine type communication gateway—a central base station. The massive Internet of Things devices construct an end-to-end connection with their corresponding machine type communication gateway (which can be based on protocols such as TCP/UDP/QUIC), and send short data packets to the machine type communication gateway at a fixed frequency according to their own function. In addition to low-level header information, these short data packets further include valid data such as sensing collection information and control feedback information, etc. The machine type communication gateway constructs an end-to-end connection with the central base station based on the QUIC protocol and forwards valid data in short data packets sent by massive Internet of Things devices. The machine type communication gateway collects the number and information of the massive Internet of Things devices connected to the machine type communication gateway, establishes, on the connection with the central base station, parallel QUIC data streams whose number is equal to the number of Internet of Things devices connected to the machine type communication gateway itself, and constructs an one-to-one mapping relationship between all Internet of Things devices and the QUIC data streams.

In addition to constructing an independent to-be-sent queue for storing to-be-sent data for each QUIC data stream, the machine type communication gateway can further construct one data stream queuing queue, which is configured to save QUIC data stream whose to-be-sent queues contain the to-be-sent data, and queue the QUIC data streams in chronological order in which the to-be-sent data is received in the to-be-sent queues for the QUIC data streams. Step 1 further includes:
adding the acquired QUIC data streams into the data stream queuing queue,

Step 2 further includes:
newly creating an empty data packet; popping up the to-be-sent data one by one from a to-be-sent queue for each queued QUIC data stream according to a queuing sequence of the QUIC data streams in the data stream queuing queue; encapsulating the popped-up to-be-sent data into one streamframe and then loading the streamframe into the newly created data packet; popping up the QUIC data stream from the data stream queuing queue; and finally sending the data packet loaded with multiple streamframes to the central base station.

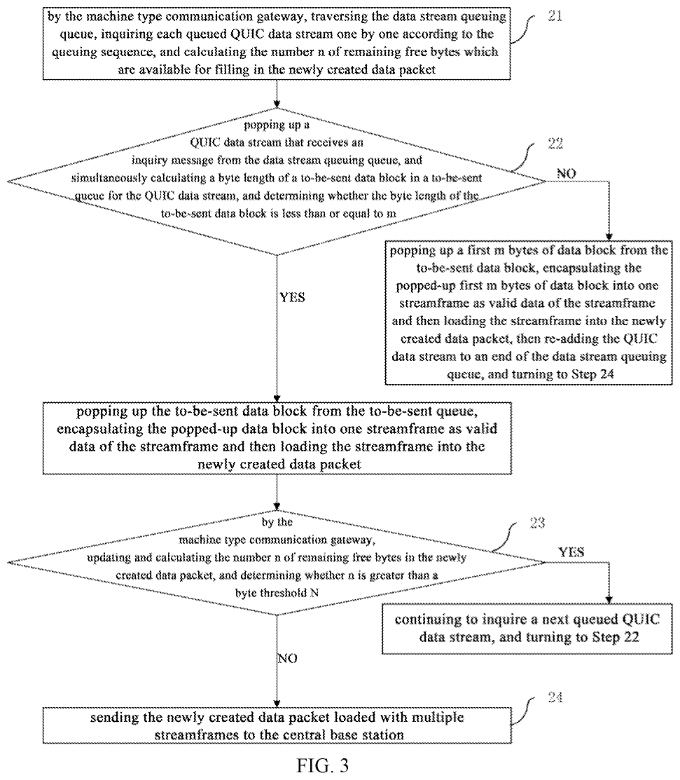

As shown in FIG. 3, Step 2 may further includes:
Step 21. by the machine type communication gateway, traversing the data stream queuing queue, inquiring each queued QUIC data stream one by one according to the queuing sequence, and calculating the number n of remaining free bytes which are available for filling in the newly created data packet;
Step 22. popping up a QUIC data stream that receives an inquiry message from the data stream queuing queue, and simultaneously calculating a byte length of a to-be-sent data block in a to-be-sent queue for the QUIC data stream, and determining whether the byte length of the to-be-sent data block is less than or equal to the number m of remaining valid bytes of the newly created data packet, wherein m is a difference value between n and a byte length (for example, 29) of header information of a QUIC streamframe; if the byte length of the to-be-sent data block is less than or equal to the number m of remaining valid bytes of the newly created data packet, popping up the to-be-sent data block from the to-be-sent queue, encapsulating the popped-up data block into one streamframe as valid data of the streamframe and then loading the streamframe into the newly created data packet, and continuing to Step 23; if the byte length of the to-be-sent data block is larger than the number m of remaining valid bytes of the newly created data packet, popping up a first m bytes of data block from the to-be-sent data block, encapsulating the popped-up first m bytes of data block into one streamframe as valid data of the streamframe and then loading the streamframe into the newly created data packet, then re-adding the QUIC data stream to an end of the data stream queuing queue, and turning to Step 24;
Step 23. by the machine type communication gateway, updating and calculating the number n of remaining free bytes in the newly created data packet, and determining whether n is greater than a byte threshold N (for example, 128); if n is greater than the byte threshold N, continuing to inquire a next queued QUIC data stream, and turning to Step 22; if n is not greater than the byte threshold N, continuing to Step 24;
Step 24. sending the newly created data packet loaded with multiple streamframes to the central base station.

It should be noted that the to-be-sent queue for each QUIC data stream can further include a retransmission data sending queue and a new data sending queue, wherein the retransmission data sending queue is configured to store a data block of the data stream which was previously sent but is to be retransmitted due to reasons such as a packet loss and the like, and the new data sending queue is configured to store a data block that has not been sent yet. Step 22 can further include:
Step 221. the QUIC data stream inquiring its own retransmission data sending queue, and determining whether there is the to-be-sent data in the retransmission data sending queue; if there is the to-be-sent data in the retransmission data sending queue, continuing to Step 222; if there is not the to-be-sent data in the retransmission data sending queue, continuing to Step 223;
Step 222. popping up the QUIC data stream from the data stream queuing queue, and determining whether a byte length of the to-be-sent data in the retransmission data sending queue is less than or equal to m; if the byte length of the to-be-sent data in the retransmission data sending queue is less than or equal to m, popping up the to-be-sent data from the retransmission data sending queue, encapsulating the popped-up data block into one streamframe and then loading the streamframe into the newly created data packet, and continuing to Step 23; if the byte length of the to-be-sent data in the retransmission data sending queue is larger than m, popping up the first m bytes of data block from the retransmission data sending queue, encapsulating the popped-up first m bytes of data block into one streamframe and then loading the streamframe into the newly created data packet, then re-adding the QUIC data stream to an end of the data stream queuing queue, and continuing to Step 24;
Step 223. popping up the QUIC data stream from the data stream queuing queue, and determining whether a byte length of the to-be-sent data in the new data sending queue is less than or equal to m; if the byte length of the to-be-sent data in the new data sending queue is less than or equal to m, popping up the to-be-sent data from the new data sending queue, encapsulating the popped-up data block into one streamframe and then loading the streamframe into the newly created data packet, and continuing to Step 23; if the byte length of the to-be-sent data in the new data sending queue is larger than m, popping up the first m bytes of data block from the new data sending queue, encapsulating the popped-up first m bytes of data block into one streamframe and then loading the streamframe into the newly created data packet, then re-adding the QUIC data stream to an end of the data stream queuing queue, and continuing to Step 24.

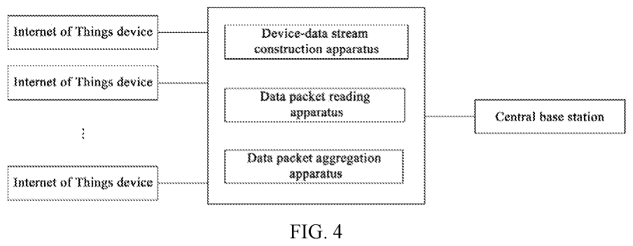

Referring to FIG. 4, FIG. 4 shows a schematic structure diagram of a data transmission system for Internet of Things devices provided by a second embodiment of the present disclosure, the data transmission system including a central base station, a machine type communication gateway and multiple Internet of Things devices, the machine type communication gateway further includes:
a device-data stream construction apparatus, configured to collect information of all of Internet of Things devices connected to the machine type communication gateway, allocate one independent QUIC data stream to each of the Internet of Things devices connected to the machine type communication gateway, and construct one to-be-sent queue for each QUIC data stream;
a data packet reading apparatus, configured to read short data packets sent by all of the Internet of Things devices, acquire QUIC data streams corresponding to the Internet of Things devices sending the short data packets, and place data in the short data packets into to-be-sent queues of the acquired QUIC data streams;
a data packet aggregation apparatus, configured to newly create an empty data packet; pop up, in chronological order in which to-be-sent data is placed into the to-be-sent queues of the QUIC data streams, the to-be-sent data one by one from a to-be-sent queue for each of QUIC data streams that contains the to-be-sent data; encapsulate the popped-up to-be-sent data into one streamframe and then load the streamframe into the newly created data packet; and finally send the data packet loaded with multiple streamframes to the central base station,
wherein the Internet of Things devices are configured to send the short data packets to the machine type communication gateway, and the short data packets also include valid data such as sensing collection information and control feedback information, etc., in addition to low-level header information;
the central base station is configured to disassemble the data packet sent by the machine type communication gateway into multiple streamframes, and read a Stream ID in header information of each of the streamframes to acquire a corresponding QUIC data stream, place valid data read from the streamframe into a buffer area of an Internet of Things device corresponding to the QUIC data stream according to a corresponding relationship between the Internet of Things devices and the QUIC data streams, to wait for being read by an application program, wherein the valid data is referred to data that does not contain the header information in the streamframe of the data packet.

In addition to constructing an independent to-be-sent queue for storing to-be-sent data for each QUIC data stream, the machine type communication gateway further constructs one data stream queuing queue, which is configured to save QUIC data streams whose to-be-sent queues contain the to-be-sent data, and queue the QUIC data streams in chronological order in which the to-be-sent data is received in the to-be-sent queues for the QUIC data streams, so that upon acquiring the QUIC data streams corresponding to the Internet of Things devices sending the short data packets, the data packet reading apparatus further adds the acquired QUIC data streams into the data stream queuing queue,
the data packet aggregation apparatus is further configured to: newly create an empty data packet; pop up the to-be-sent data one by one from a to-be-sent queue for each queued QUIC data stream according to a queuing sequence of the QUIC data streams in the data stream queuing queue; encapsulate the popped-up to-be-sent data into one streamframe and then load the streamframe into the newly created data packet; pop up the QUIC data stream from the data stream queuing queue; and finally sending the data packet loaded with multiple streamframes to the central base station.

The data packet aggregation apparatus of the machine type communication gateway may further include a data stream queuing processing unit, a data assembling unit, a data sending unit and multiple QUIC data stream units, wherein:
the data stream queuing process unit is configured to traverse the data stream queuing queue; inquire each queued QUIC data stream one by one according to the queuing sequence, and calculate the number n of remaining free bytes that are available for padding in the newly created data packet; then update and calculate the number n of remaining free bytes in the newly created data packet according to a response message of a QUIC data stream unit; determine whether n is greater than a byte threshold N; if n is greater than the byte threshold N, continue to inquire a next queued QUIC data stream; if n is not greater than the byte threshold N, inform a data sending unit to send the data packet;
the QUIC data stream unit is configured to pop up, from the data stream queuing queue, a QUIC data stream that receives an inquiry message sent by the data stream queuing processing unit, and simultaneously calculate a byte length of a to-be-sent data block in a to-be-sent queue for the QUIC data stream unit, and determine whether the byte length of the to-be-sent data block is less than or equal to the number m of remaining valid bytes of the newly created data packet, wherein m is a difference value between n and a byte length of header information of the QUIC streamframe; if the byte length of the to-be-sent data block is less than or equal to the number m of remaining valid bytes of the newly created data packet, pop up the to-be-sent data block from the to-be-sent queue and send the popped-up to-be-sent data block to the data assembling unit, and then reply the response message back to the data stream queuing processing unit; if the byte length of the to-be-sent data block is larger than the number m of remaining valid bytes of the newly created data packet, pop up a first m bytes of data block from the to-be-sent data block, and send the popped-up first m bytes of data block to the data assembling unit, then re-add the QUIC data stream to an end of the data stream queuing queue, and inform the data sending unit to send the data packet;
the data assembling unit is configured to encapsulate the data block sent by the QUIC data stream unit into one streamframe as valid data of the streamframe, set a Stream ID of the streamframe as ID of a corresponding QUIC data stream, and then load the streamframe into the newly created data packet;
the data sending unit is configured to send the newly created data packet loaded with multiple streamframes to the central base station.

The above descriptions are only preferred embodiments of the present disclosure, and are not intended to limit the present disclosure. Any modifications, equivalent replacements, improvements and the like made within the spirit and principles of the present disclosure shall be included within the scope of protection of the present disclosure.

1. A data transmission method for Internet of Things devices, wherein a machine type communication gateway collects information of all of Internet of Things devices connected to the machine type communication gateway, allocates one QUIC data stream to each of the Internet of Things devices connected to the machine type communication gateway, and constructs one to-be-sent queue for each QUIC data stream; when the machine type communication gateway receives short data packets sent by the Internet of Things devices, the method comprises:
Step 1. by the machine type communication gateway, reading the short data packets sent by all of the Internet of Things devices, acquiring QUIC data streams corresponding to the Internet of Things devices sending the short data packets, and placing data in the short data packets into to-be-sent queues for the acquired QUIC data streams;
Step 2. by the machine type communication gateway, newly creating an empty data packet; popping up, in chronological order in which to-be-sent data is placed into the to-be-sent queues for the QUIC data streams, the to-be-sent data one by one from a to-be-sent queue for each of QUIC data streams that contains the to-be-sent data; encapsulating the popped-up to-be-sent data into one streamframe and then loading the streamframe into the newly created data packet; and finally sending the data packet loaded with multiple streamframes to a central base station.

2. The method according to claim 1, wherein when the central base station receives the data packet sent by the machine type communication gateway, the method further comprises:
by the central base station, disassembling the data packet sent by the machine type communication gateway into multiple streamframes, and reading a Stream ID in header information of each of the streamframes to acquire a corresponding QUIC data stream; then placing valid data read from the streamframe into a buffer area of an Internet of Things device corresponding to the QUIC data stream according to a corresponding relationship between the Internet of Things devices and the QUIC data streams, to wait for being read by an application program, wherein the valid data is referred to data that does not contain the header information in the streamframe of the data packet.

3. The method according to claim 1, wherein the machine type communication gateway further constructs one data stream queuing queue, which is configured to save QUIC data streams whose to-be-sent queues contain the to-be-sent data, and queue the QUIC data streams in chronological order in which the to-be-sent data is received in the to-be-sent queues for the QUIC data streams; Step 1 further comprises:
adding the acquired QUIC data streams into the data stream queuing queue,
Step 2 further comprises:
newly creating an empty data packet; popping up the to-be-sent data one by one from a to-be-sent queue for each queued QUIC data stream according to a queuing sequence of the QUIC data streams in the data stream queuing queue; encapsulating the popped-up to-be-sent data into one streamframe and then loading the streamframe into the newly created data packet; popping up the QUIC data stream from the data stream queuing queue; and finally sending the data packet loaded with multiple streamframes to the central base station.

4. The method according to claim 3, wherein Step 2 further comprises:
Step 21. by the machine type communication gateway, traversing the data stream queuing queue, inquiring each queued QUIC data stream one by one according to the queuing sequence, and calculating the number n of remaining free bytes in the newly created data packet;
Step 22. popping up a QUIC data stream that receives an inquiry message from the data stream queuing queue, and simultaneously calculating a byte length of a to-be-sent data block in a to-be-sent queue for the QUIC data stream, and determining whether the byte length of the to-be-sent data block is less than or equal to the number m of remaining valid bytes of the newly created data packet, wherein m is a difference value between n and a byte length of header information of a QUIC streamframe; if the byte length of the to-be-sent data block is less than or equal to the number m of remaining valid bytes of the newly created data packet, popping up the to-be-sent data block from the to-be-sent queue, encapsulating the popped-up data block into one streamframe as valid data of the streamframe and then loading the streamframe into the newly created data packet, and continuing to Step 23; if the byte length of the to-be-sent data block is larger than the number m of remaining valid bytes of the newly created data packet, popping up a first m bytes of data block from the to-be-sent data block, encapsulating the popped-up first m bytes of data block into one streamframe as valid data of the streamframe and then loading the streamframe into the newly created data packet, then re-adding the QUIC data stream to an end of the data stream queuing queue, and turning to Step 24;
Step 23. by the machine type communication gateway, updating and calculating the number n of remaining free bytes in the newly created data packet, and determining whether n is greater than a byte threshold N; if n is greater than the byte threshold N, continuing to inquire a next queued QUIC data stream, and turning to Step 22; if n is not greater than the byte threshold N, continuing to Step 24;
Step 24. sending the newly created data packet loaded with multiple streamframes to the central base station.

5. The method according to claim 4, wherein the to-be-sent queue for each QUIC data stream further comprises a retransmission data sending queue and a new data sending queue, wherein the retransmission data sending queue is configured to store a data block of the data stream which was previously sent but is to be retransmitted, and the new data sending queue is configured to store a data block that has not been sent yet; Step 22 further comprises:
Step 221. the QUIC data stream inquiring its own retransmission data sending queue, and determining whether there is the to-be-sent data in the retransmission data sending queue; if there is the to-be-sent data in the retransmission data sending queue, continuing to Step 222; if there is not the to-be-sent data in the retransmission data sending queue, continuing to Step 223;
Step 222. popping up the QUIC data stream from the data stream queuing queue, and determining whether a byte length of the to-be-sent data in the retransmission data sending queue is less than or equal to m; if the byte length of the to-be-sent data in the retransmission data sending queue is less than or equal to m, popping up the to-be-sent data from the retransmission data sending queue, encapsulating the popped-up data block into one streamframe and then loading the streamframe into the newly created data packet, and continuing to Step 23; if the byte length of the to-be-sent data in the retransmission data sending queue is larger than m, popping up the first m bytes of data block from the retransmission data sending queue, encapsulating the popped-up first m bytes of data block into one streamframe and then loading the streamframe into the newly created data packet, then re-adding the QUIC data stream to an end of the data stream queuing queue, and continuing to Step 24;
Step 223. popping up the QUIC data stream from the data stream queuing queue, and determining whether a byte length of the to-be-sent data in the new data sending queue is less than or equal to m; if the byte length of the to-be-sent data in the new data sending queue is less than or equal to m, popping up the to-be-sent data from the new data sending queue, encapsulating the popped-up data block into one streamframe and then loading the streamframe into the newly created data packet, and continuing to Step 23; if the byte length of the to-be-sent data in the new data sending queue is larger than m, popping up the first m bytes of data block from the new data sending queue, encapsulating the popped-up first m bytes of data block into one streamframe and then loading the streamframe into the newly created data packet, then re-adding the QUIC data stream to an end of the data stream queuing queue, and continuing to Step 24.

6. A data transmission system for Internet of Things devices, comprising a central base station, a machine type communication gateway and multiple Internet of Things devices, wherein the machine type communication gateway comprises:
a device-data stream construction apparatus, configured to collect information of all of Internet of Things devices connected to the machine type communication gateway, allocate one QUIC data stream to each of the Internet of Things devices connected to the machine type communication gateway, and construct one to-be-sent queue for each QUIC data stream;
a data packet reading apparatus, configured to read short data packets sent by all of the Internet of Things devices, acquire QUIC data streams corresponding to the Internet of Things devices sending the short data packets, and place data in the short data packets into to-be-sent queues of the acquired QUIC data streams;
a data packet aggregation apparatus, configured to newly create an empty data packet; pop up, in chronological order in which to-be-sent data is placed into the to-be-sent queues of the QUIC data streams, the to-be-sent data one by one from a to-be-sent queue for each of QUIC data streams that contains the to-be-sent data; encapsulate the popped-up to-be-sent data into one streamframe and then load the streamframe into the newly created data packet; and finally send the data packet loaded with multiple streamframes to the central base station.

7. The system according to claim 6, wherein
the central base station is configured to disassemble the data packet sent by the machine type communication gateway into multiple streamframes, and read a Stream ID in header information of each of the streamframes to acquire a corresponding QUIC data stream, place valid data read from the streamframe into a buffer area of an Internet of Things device corresponding to the QUIC data stream according to a corresponding relationship between the internet of Things devices and the QUIC data streams, to wait for being read by an application program, wherein the valid data is referred to data that does not contain the header information in the streamframe of the data packet.

8. The system according to claim 6, wherein the machine type communication gateway further constructs one data stream queuing queue, which is configured to save QUIC data streams whose to-be-sent queues contain the to-be-sent data, and queue the QUIC data streams in chronological order in which the to-be-sent data is received in the to-be-sent queues for the QUIC data streams, so that upon acquiring the QUIC data streams corresponding to the Internet of Things devices sending the short data packets, the data packet reading apparatus further adds the acquired QUIC data streams into the data stream queuing queue,
the data packet aggregation apparatus is further configured to: newly create an empty data packet; pop up the to-be-sent data one by one from a to-be-sent queue for each queued QUIC data stream according to a queuing sequence of the QUIC data streams in the data stream queuing queue; encapsulate the popped-up to-be-sent data into one streamframe and then load the streamframe into the newly created data packet; pop up the QUIC data stream from the data stream queuing queue; and finally sending the data packet loaded with multiple streamframes to the central base station.

9. The system according to claim 8, wherein the data packet aggregation apparatus of the machine type communication gateway comprises:
a data stream queuing processing unit, configured to traverse the data stream queuing queue; inquire each queued QUIC data stream one by one according to the queuing sequence, and calculate the number n of remaining free bytes that are available for filling in the newly created data packet; then update and calculate the number n of remaining free bytes in the newly created data packet according to a response message of a QUIC data stream unit; determine whether n is greater than a byte threshold N; if n is greater than the byte threshold N, continue to inquire a next queued QUIC data stream; if n is not greater than the byte threshold N, inform a data sending unit to send the data packet;
QUIC data stream units, each of which being configured to pop up, from the data stream queuing queue, a QUIC data stream that receives an inquiry message sent by the data stream queuing processing unit, and simultaneously calculate a byte length of a to-be-sent data block in a to-be-sent queue for the QUIC data stream unit, and determine whether the byte length of the to-be-sent data block is less than or equal to the number m of remaining valid bytes of the newly created data packet, wherein m is a difference value between n and a byte length of header information of the QUIC streamframe; if the byte length of the to-be-sent data block is less than or equal to the number m of remaining valid bytes of the newly created data packet, pop up the to-be-sent data block from the to-be-sent queue and send the popped-up to-be-sent data block to a data assembling unit, and then reply the response message back to the data stream queuing processing unit; if the byte length of the to-be-sent data block is larger than the number m of remaining valid bytes of the newly created data packet, pop up a first m bytes of data block from the to-be-sent data block, and send the popped-up first m bytes of data block to the data assembling unit, then re-add the QUIC data stream to an end of the data stream queuing queue, and inform the data sending unit to send the data packet;
the data assembling unit, configured to encapsulate the data block sent by the QUIC data stream unit into one streamframe as valid data of the streamframe, set a Stream ID of the streamframe as ID of a corresponding QUIC data stream, and then load the streamframe into the newly created data packet;
the data sending unit, configured to send the newly created data packet loaded with multiple streamframes to the central base station.
